(19) United States
(12) Patent Application Publication
(10) Pub. No.: US 2021/0140838 A1
(43) Pub. Date: May 13, 2021

(54) CAMSHAFT TORQUE MEASUREMENT ARRANGEMENT

(71) Applicant: DELPHI TECHNOLOGIES IP LIMITED, ST. MICHAEL (BB)

(72) Inventors: CHRISTOPHER J. STEELE, ROCHESTER, NY (US); JONGMIN LEE, PITTSFORD, NY (US)

(21) Appl. No.: 16/677,967

(22) Filed: Nov. 8, 2019

(51) Int. Cl. G01L 3/14; F01M 11/10

(52) U.S. Cl. CPC G01L 3/1457; F01M 2250/62; F01M 11/10; G01L 3/1464

(57) ABSTRACT

An arrangement for measuring torque on a camshaft includes a hub extending from a hub first end distal from the camshaft to a hub second end proximal to the camshaft. A barrel extends from a barrel first end distal from the camshaft to a barrel second end and has a barrel bore extending thereinto from the barrel second end such that the hub is received within the barrel bore in a close-sliding interface. The barrel is fixed to the hub at an interface such that relative rotation between the barrel and the hub about the axis is prevented at the interface and the close-sliding interface does not contribute to transmission of torque between the barrel and the hub. A strain gage is located on the barrel between the barrel second end and interface which varies in resistance according to a magnitude of torque transmitted between the barrel and the camshaft.

### TECHNICAL FIELD OF INVENTION

The present disclosure relates to an arrangement for measuring torque in a camshaft for an internal combustion engine.

### BACKGROUND OF INVENTION

Modern designs for combustion gas flow in internal combustion engines typically include an arrangement of poppet valves in the top of the combustion chamber. Traditional systems generate valve opening and closing motion from the camming action of eccentric lobes on a camshaft which sources its rotational energy from the crankshaft driven by reciprocation of pistons of the internal combustion engine. Since both the camshaft and the crankshaft are often mechanically de-coupled by a variable valve timing device, for example a hydraulic camshaft phaser, the real camshaft motion is convoluted by reaction forces of each valve and by accessory loads, for example a high-pressure fuel pump or vacuum pump. Implementing advanced combustion strategies, e.g. Miller, Atkinson, EGR, or lean-burn, and reducing energy loss such as friction are both increasingly important to manufacturers of internal combustion engines, and depend on a thorough understanding of camshaft motion. Therefore, it is essential to understand the force and energy balance acting on the camshaft.

The most accurate computer models of valvetrain systems still rely on real-world data for correlation. Measurements of dimensions and material properties have become trivial for well-equipped metrology departments; static and quasi-static force balances too, even for the most complex geometry. However, this is not true for dynamic measurements of the camshaft, where real-world data is difficult to generate. Prior attempts to measure input and reaction torque to define the energy balance on the camshaft have required modifications to the hardware and the operating environment. Concessions for measuring camshaft torque typically include:
limiting the operating envelope because of rotational imbalance or instrument durability concerns;
extensive modification of the camshaft to accept instruments, e.g. material removal to increase strain gage sensitivity, or to make room for transmitters;
incomplete data across the range of engine temperature, because of thermal limits of the instruments;
dedicated prototypes that have high initial cost, long lead time, and no future use; and
inability to measure the total range of torque, from steady-state bearing friction to peak acceleration during full load.

Previous examples of camshaft torque measurement can be found throughout the automotive industry. Measurements are generally requested during the design confirmation and design validation stages of valvetrain projects, and sometimes for advanced development projects as well. The primary methods of collecting camshaft torque are split between external transducers and integrated transducers.

External transducers provide the benefit of being free from packaging constraints. A transducer manufacturer may produce many high-quality meters, in multiple load ranges, built in the same form factor for customer convenience. However, they distort the dynamics of the system because of the increased mass and absence of the timing chain drive, which does impart loads from other components in the system. This means dynamics data is not perfect, but is a good estimate for valvetrain dynamics. The steady state and dynamic camshaft friction is very accurate as well. However, the systems are typically not robust to a wide range of temperatures, and are often not rated for continuous contact with motor oil, thereby limiting the operating temperature of the test stand. Furthermore, external torque transducers can be used only for cylinder head motoring tests since it needs to be installed between the driving motor and camshaft.

Integrated transducers are developed on a case-by-case basis for each engine program. This has been done in the past to compliment motored cylinder head testing, filling in the missing dynamic data to go along with friction data. Prototype hardware is taken from the manufacturer and instrumented with strain sensing elements, i.e. strain gages, that are situated somewhere along the shaft. Exact placement of the elements can have a large impact on the data that comes from the system. If a gage is placed in an area with a large shaft diameter, the strain sensitivity may be reduced or drowned out entirely by noise. It is also difficult, and often impossible, to place the sensing element between the timing drive sprocket and the first camshaft bearing. Locating the gage further down the camshaft will impair the ability to measure accurate camshaft friction, and if placed after a cam lobe, will remove the ability to sense that lobe's contribution to reaction torque. The typical methods of routing the signal out of the rocker-box is to use a slip ring circuit, or a wireless telemetry system. Both have packaging drawbacks associated with their design and mounting location.

What is needed is a camshaft torque measurement arrangement which minimizes or eliminates one or more of the shortcomings as set forth above.

### SUMMARY OF THE INVENTION

Briefly describe, the present disclosure provides a camshaft torque measurement arrangement which measures torque on a camshaft which rotates about an axis. The camshaft torque measurement arrangement comprises a hub extending along the axis from a hub first end distal from the camshaft to a hub second end proximal to the camshaft such that the hub is configured to be fixed to an axial end of the camshaft; a barrel extending along the axis from a barrel first end distal from the camshaft to a barrel second end proximal to the camshaft, the barrel having a barrel bore extending thereinto from the barrel second end such that the hub is received within the barrel bore in a close-sliding interface, wherein the barrel is fixed to the hub at a barrel to hub interface such that relative rotation between the barrel and the hub about the axis is prevented at the barrel to hub interface, and wherein the close-sliding interface does not contribute to transmission of torque between the barrel and the hub; and a strain gage on the barrel between the barrel second end and the barrel to hub interface which varies in resistance according to a magnitude of torque transmitted between the drive member and the camshaft.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a cross-sectional view of an internal combustion engine in accordance with the present invention;

FIG. 2 is a view showing a valve train system of the internal combustion engine;

FIG. 3 is an isometric view of a camshaft and a camshaft torque measurement arrangement in accordance with the present disclosure

FIG. 4 is an exploded isometric view of FIG. 3;

FIG. 5 is partial section view of FIG. 3;

FIG. 6 is an axial cross-sectional view of the camshaft and the camshaft torque measurement arrangement;

FIG. 6A is a radial cross-sectional view of a portion of the camshaft torque measurement arrangement;

FIG. 7 is a schematic of a strain gage and slip ring assembly of the camshaft torque measurement arrangement; and

FIG. 8 is a schematic of the slip ring assembly and a controller in accordance with the present disclosure.

### DETAILED DESCRIPTION OF INVENTION

In accordance with a preferred embodiment of this disclosure and referring initially to FIGS. 1 and 2, an internal combustion engine 10 is illustrated, by way of non-limiting example only, as a four-cylinder, dual overhead cam internal combustion engine. Internal combustion engine 10 includes valve train system 12 for allowing at least a charge of air into combustion chamber 14 and for allowing exhaust constituents out of combustion chamber 14. Piston 16 is disposed within combustion chamber 14 and is reciprocatable between a top-dead-center (TDC) position (shown as solid lines in FIG. 1) and a bottom dead center (BDC) position (shown as phantom lines in FIG. 1) resulting from combustion of a mixture of fuel and air in combustion chamber 14 where the fuel may be injected directly into each combustion chamber 14 by a respective fuel injector 15. A lower end of piston 16 is attached to crankshaft 18 which turns reciprocating motion of piston 16 into rotary motion. As embodied herein, each combustion chamber 14 includes two intake valves 20 which open and close to allow at least a charge of air into combustion chamber 14 and also includes two exhaust valves 22 which open and close to allow exhaust constituents out of combustion chamber 14, however, it should be understood that different quantities of intake valves 20 and exhaust valves 22 may be utilized as is known to those of ordinary skill in the art of internal combustion engines. In order to open and close intake valves 20, internal combustion engine 10 includes an intake camshaft 24 with a plurality of intake lobes 24a such that each intake lobe 24a is associated with a respective one of intake valves 20. Intake camshaft 24 rotates about an intake camshaft axis 24b through a drive chain 26 connected to crankshaft 18, however, it should be understood that intake camshaft 24 may alternatively be driven by a belt, gear, or other drive means known to those of ordinary skill in the art of internal combustion engines. A respective intake rocker arm 28 is provide for each intake valve 20 such that each intake rocker arm 28 follows the profile of its respective intake lobe 24a as intake camshaft 24 rotates about intake camshaft axis 24b. One end of intake rocker arm 28 pivots about an intake lash adjuster 30 while the other end of intake rocker arm 28 engages a valve stem 20a of intake valve 20. As a result, pivoting of intake rocker arm 28 about intake lash adjuster 30 causes intake valve 20 to open and close. Similarly, in order to open and close exhaust valves 22, internal combustion engine 10 includes an exhaust camshaft 32 with a plurality of exhaust lobes 32a such that each exhaust lobe 32a is associated with a respective one of exhaust valves 22. Exhaust camshaft 32 rotates about an exhaust camshaft axis 32b through drive chain 26 connected to crankshaft 18, however, it should be understood that exhaust camshaft 32 may alternatively be driven by a belt, gear, or other drive means known to those of ordinary skill in the art of internal combustion engines. A respective exhaust rocker arm 34 is provide for each exhaust valve 22 such that each exhaust rocker arm 34 follows the profile of its respective exhaust lobe 32a as exhaust camshaft 32 rotates about exhaust camshaft axis 32b. One end of exhaust rocker arm 34 pivots about an exhaust lash adjuster 36 while the other end of exhaust rocker arm 34 engages a valve stem 22a of exhaust valve 22. As a result, pivoting of exhaust rocker arm 34 about exhaust lash adjuster 36 causes exhaust valve 22 to open and close. While internal combustion engine 10 has been illustrated herein as including intake camshaft 24 and exhaust camshaft 32, it should be understood that a single camshaft may alternatively be provided to include both intake lobes 24a and exhaust lobes 32a as known to those of ordinary skill in the art of internal combustion engines. Similarly, while internal combustion engine 10 has been illustrated herein an in-line four-cylinder internal combustion engine, it should be understood that other quantities of cylinders may be employed with the cylinders in-line or in different configures such as in a “V” configuration, opposed configuration, or other configuration known to those of ordinary skill in the art of internal combustion engines.

In order to measure torque on intake camshaft 24 and exhaust camshaft 32, intake camshaft 24 and exhaust camshaft 32 are each provided with a respective camshaft torque measurement arrangement 38, however, since each respective camshaft torque measurement arrangement 38 is the same for each of intake camshaft 24 and exhaust camshaft 32, camshaft torque measurement arrangement 38 for intake camshaft 24 will be described with the understanding that the description is equally applicable to exhaust camshaft 32. The elements of camshaft torque measurement arrangement 38 will be described in detail in the paragraphs that follow.

Now with particular reference to FIGS. 3-6a, camshaft torque measurement arrangement 38 includes a hub 40 which is centered about, and extends along intake camshaft axis 24b such that hub 40 extends from a hub first end 40a which is distal from intake camshaft 24 to a hub second end 40b which is proximal to intake camshaft 24. Hub 40 includes a hub bore 42 extending axially therethrough from hub first end 40a to hub second end 40b such that hub bore 42 is centered about intake camshaft axis 24b. Hub bore 42 accommodates an attachment bolt 44 which clamps hub 40 to intake camshaft 24 such that relative rotation between hub 40 and intake camshaft 24 is prevented.

Hub bore 42 is stepped, thereby establishing sections of distinct diameter. A hub bore first section 42a of hub bore 42 initiates at hub first end 40a and extends, preferably at a uniform diameter, to a hub bore first shoulder 42b which is traverse to intake camshaft axis 24b and which is preferably perpendicular to intake camshaft axis 24b. Hub bore first section 42a is sized to accommodate a head 44a of attachment bolt 44 which is used to rotate attachment bolt 44 when attachment bolt 44 is tightened to intake camshaft 24 and which engages hub bore first shoulder 42b. Extending from hub bore first shoulder 42b toward hub second end 40b is a hub bore second section 42c which is smaller in diameter than hub bore first section 42a. Hub bore second section 42c may itself include sections of varied diameter and accommodates a shank 44b of attachment bolt 44. A hub bore third section 42d extends from hub second end 40b to hub bore second section 42c. Hub bore third section 42d is larger in diameter than hub bore second section 42c, thereby forming a hub bore second shoulder 42e where hub bore third section 42d meets hub bore second section 42c such that hub bore second shoulder 42e is traverse to intake camshaft axis 24b and is preferably perpendicular to intake camshaft axis 24b. An intake camshaft axial end 24c of intake camshaft 24 is received within hub bore third section 42d while a threaded section 44c of attachment bolt 44 extends into an intake camshaft threaded bore 24d of intake camshaft 24 and is threadably engaged therewith. Consequently, when attachment bolt 44 is tightened, i.e. rotated in a direction which causes the threads of attachment bolt 44 and intake camshaft threaded bore 24d to draw head 44a toward intake camshaft 24, the portion of hub 40 between hub bore first shoulder 42b and hub bore second shoulder 42e is compressed between intake camshaft 24 and head 44a of attachment bolt 44, there fixing hub 40 to intake camshaft 24 and preventing relative rotation therebetween.

Hub 40 includes a hub outer periphery first section 40c on an out periphery thereof such that hub outer periphery first section 40c is centered about, and extends along, intake camshaft axis 24b. Hub outer periphery first section 40c is preferably cylindrical and extends from hub first end 40a toward hub second end 40b where hub outer periphery first section 40c is delimited by a hub external shoulder 40d which is traverse to intake camshaft axis 24b and is preferably perpendicular to intake camshaft axis 24b. The outer periphery of hub 40 also includes a hub outer periphery second section 40e which extends from hub external shoulder 40d to hub second end 40b such that hub outer periphery second section 40e is centered about, and extends along, intake camshaft axis 24b and is preferably cylindrical.

Camshaft torque measurement arrangement 38 also includes a barrel 46 which is centered about, and extends along intake camshaft axis 24b such that barrel 46 extends from a barrel first end 46a which is distal from intake camshaft 24 to a barrel second end 46b which is proximal to intake camshaft 24. Barrel 46 includes a barrel bore 48 extending axially therethrough from barrel first end 46a to barrel second end 46b such that barrel bore 48 is centered about intake camshaft axis 24b.

Barrel bore 48 is stepped, thereby establishing sections of distinct diameter. A barrel bore first section 48a of barrel bore 48 initiates at barrel first end 46a and extends, preferably at a uniform diameter, to a barrel bore shoulder 48b which is traverse to intake camshaft axis 24b and faces toward barrel second end 46b and which is preferably perpendicular to intake camshaft axis 24b. Barrel bore shoulder 48b axially abuts hub first end 40a and is fixed thereto at a barrel to hub interface 50, as will be described in greater detail later, such that relative rotation between barrel 46 and hub 40 at barrel to hub interface 50 is prevented. Barrel bore first section 48a is centered about, and extends along, intake camshaft axis 24b and is sized to allow passage of head 44a of attachment bolt 44 therethrough when attachment bolt 44 is used to clamp hub 40 to intake camshaft 24. Extending from barrel bore shoulder 48b to barrel second end 46b is a barrel bore second section 48c within which hub outer periphery first section 40c is located in a close-sliding interface which substantially prevents relative radial movement between hub 40 and barrel 46 while allowing hub outer periphery first section 40c to be inserted into barrel bore second section 48c without interference. In one non-limiting example, the close-sliding interface is less than or equal to 10 microns in radial clearance. Barrel bore second section 48c is centered about, and extends along, intake camshaft axis 24b and is preferably cylindrical in shape.

Barrel 46 includes a barrel first flange 46c at barrel first end 46a which extends radially outward from barrel bore first section 48a and extends axially to the same extent as barrel bore first section 48a. A plurality of barrel first flange apertures 46d extend axially therethrough from barrel first end 46a to barrel bore shoulder 48b which are aligned with complementary hub apertures 40f which are threaded. A plurality of barrel to hub threaded fasteners 52 extend through barrel first flange apertures 46d and threadably engage hub apertures 40f. Barrel to hub threaded fasteners 52 are tightened, thereby clamping barrel 46 and hub 40 together at barrel to hub interface 50.

Barrel 46 also includes a barrel second flange 46e at barrel second end 46b which extends radially outward from barrel bore second section 48c and extends axially toward, but not to, barrel first flange 46c. A plurality of barrel second flange apertures 46f extend axially therethrough to barrel second end 46b, the purpose of which will be described in greater detail later.

Barrel 46 also includes a barrel intermediate section 46g which extends from barrel first flange 46c to barrel second flange 46e and which extends radially outward from barrel bore second section 48c. It is important to note that barrel intermediate section 46g has a thickness, i.e. in a direction radially relative to intake camshaft axis 24b, which is less that both barrel first flange 46c and barrel second flange 46e. As a result, barrel intermediate section 46g has a first torsional rigidity, barrel first flange 46c has a second torsional rigidity which is greater than the first torsional rigidity of barrel intermediate section 46g, and barrel second flange 46e has a third torsional rigidity which is greater than the first torsional rigidity of barrel intermediate section 46g. In order to further contribute to the first torsional rigidity of barrel intermediate section 46g being less than the second torsional rigidity of barrel first flange 46c and being less than the third torsional rigidity of barrel second flange 46e, barrel intermediate section 46g includes a plurality of barrel intermediate section apertures 46h extending radially therethrough from a barrel intermediate section outer surface 46i to a barrel bore second section 48c. While barrel intermediate section apertures 46h have been illustrated herein as being circular, it should be understood that barrel intermediate section apertures 46h may be other shapes such as, by way of non-limiting example only, generally square or rectangular with radiused corners. Barrel intermediate section apertures 46h make up at least 10%, but preferably less than or equal to 50%, of a cross-sectional area of barrel intermediate section 46g when barrel intermediate section 46g is sectioned through barrel intermediate section apertures 46h in a direction perpendicular to intake camshaft axis 24b (as may best be visible in FIG. 6a). Preferably, barrel intermediate section apertures 46h make up at least 34% of the cross-sectional area of barrel intermediate section 46g.

Camshaft torque measurement arrangement 38 also includes a drive member, illustrated herein by way of non-limiting example only as sprocket 54, which is centered about intake camshaft axis 24b and which is configured to be driven and rotated about intake camshaft axis 24b. Sprocket 54 includes a plurality of sprocket teeth 54a on an outer periphery thereof which mesh with drive chain 26 driven by crankshaft 18 as is known to those of ordinary skill in the art of internal combustion engines. Sprocket 54 is fixed to barrel 46 proximal to barrel second end 46b at a drive member to barrel interface 58 which as illustrated herein, may be at an abutment of sprocket 54 and barrel second end 46b. Sprocket 54 includes a sprocket central bore 54b extending axially therethrough such that a portion of hub outer periphery first section 40c is located within sprocket central bore 54b. Sprocket 54 also includes a plurality of sprocket attachment apertures 54c which are threaded and which collectively are distributed around sprocket central bore 54b in a polar array centered about intake camshaft axis 24b. Each sprocket attachment aperture 54c is aligned with a respective one of barrel second flange apertures 46f and a plurality of barrel to sprocket threaded fasteners 60 are provided such that each one of barrel to sprocket threaded fasteners 60 passes through a respective one of barrel second flange apertures 46f and threadably engages a respective one of sprocket attachment apertures 54c. Barrel to sprocket threaded fasteners 60 are tightened, thereby clamping barrel 46 to sprocket 54 at drive member to barrel interface 58 such that relative rotation between sprocket 54 and barrel 46 at drive member to barrel interface 58 is prevented.

In operation, drive chain 26 rotates sprocket 54, and since sprocket 54 is fixed to barrel 46 and barrel 46 is fixed to hub 40, rotation of sprocket 54 causes both barrel 46 and hub 40 to rotate about intake camshaft axis 24b. Furthermore, since hub 40 is fixed to intake camshaft 24, rotation of sprocket 54 causes intake camshaft 24 to rotate. However, it is important to note that the close-sliding interface between hub 40 and barrel 46 does not limit rotational movement between hub 40 and barrel 46 from barrel to hub interface 50 to hub second end 40b, and therefore, the close-sliding does not contribute to transmission of torque between barrel 46 and hub 40, i.e. from sprocket 54 to intake camshaft 24. In other words, all torque transmitted from sprocket 54 to intake camshaft 24 is through barrel to hub interface 50.

Now with additional particular reference to FIG. 7, camshaft torque measurement arrangement 38 also includes a strain gage 62 on barrel 46 between barrel second end 46b and barrel to hub interface 50 which varies in resistance according to a magnitude of torque transmitted between sprocket 54 and intake camshaft 24. More specifically, strain gage 62 is located on barrel intermediate section outer surface 46i. As illustrated herein, strain gage 62 may include four strain gage patterns 62a, 62b, 62c, 62d arranged in a Wheatstone full-bridge where opposite ends of strain gage pattern 62a are connected to respective ends of strain gage pattern 62b and strain gage pattern 62d at a junction 62e and a junction 62f respectively, opposite ends of strain gage pattern 62b are connected to respective ends of strain gage pattern 62a and strain gage pattern 62c at junction 62e and a junction 62g respectively, opposite ends of strain gage pattern 62c are connected to respective ends of strain gage pattern 62b and strain gage pattern 62d at junction 62g and a junction 62h respectively, and opposite ends of strain gage pattern 62d are connected to respective ends of strain gage pattern 62a and strain gage pattern 62c at junction 62f and junction 62h respectively. Also as illustrated herein, strain gage 62 may be arranged on barrel intermediate section outer surface 46i such that one pair of strain gage patterns 62a, 62b are located between one pair of adjacent barrel intermediate section apertures 46h and the other pair of strain gage patterns 62c, 62d are located between another pair of adjacent barrel intermediate section apertures 46h such that strain gage patterns 62a, 62b are diametrically opposed to strain gage patterns 62c, 62d as may be best seen in FIG. 6A where strain gage patterns 62a, 62b, 62c, and 62d are shown exaggerated in size for clarity. Strain gage patterns 62a, 62b, 62c, 62d may be, by way of non-limiting example only, of the arrangement available as model number SGT-1D/350-SY41 from Omega Engineering, Inc. of Norwalk, Conn., USA, however, numerous other strain gage patterns and configurations are known and may be used in alternative.

It is important to note that by placing strain gage 62 on barrel 46 between barrel second end 46b and barrel to hub interface 50, and more specifically on barrel intermediate section 46g which is thin in radial thickness and reduced in cross-sectional area by barrel intermediate section apertures 46h, strain gage 62 is able to provide a high degree of resolution. However, since barrel intermediate section 46g is provided with a close-sliding interface with hub outer periphery first section 40c, barrel intermediate section 46g is provided with support from hub 40, thereby preventing buckling which could otherwise occur if left unsupported. It is important to note that the extent to which barrel intermediate section apertures 46h reduce the cross-sectional area of barrel intermediate section 46g is selected to increase sensitivity of strain gage 62 while maintaining structural integrity of barrel intermediate section 46g, and may be dependent upon the radial thickness of barrel intermediate section 46g.

Camshaft torque measurement arrangement 38 also includes a slip ring assembly 64 which includes a slip ring rotor 64a and a slip ring stator 64b. Slip ring assembly 64 may be, by way of non-limiting example only, of the arrangement available as model number S6/Gx from Michigan Scientific Corporation of Charlevoix, Michigan, USA. Slip ring rotor 64a is fixed to barrel 46 such that slip ring rotor 64a rotates together with barrel 46. In order to fix slip ring rotor 64a to barrel 46, slip ring rotor 64a includes a plurality of slip ring rotor attachment apertures 64c (only one of which is visible in the figures) which extend therethrough parallel to intake camshaft axis 24b and which receive slip ring assembly to barrel threaded fasteners 66. Slip ring assembly to barrel threaded fasteners 66 extend into barrel attachment apertures 46j which are threaded and which threadably engage slip ring assembly to barrel threaded fasteners 66 such that slip ring to barrel threaded fasteners 66 are tightened, thereby clamping slip ring rotor 64a to barrel 46.

Slip ring rotor 64a includes slip ring rotor terminals 68a, 68b, 68c, 68d which provide electrical connection to strain gage 62. More specifically, slip ring rotor terminal 68a is electrically connected to junction 62f and provides a positive excitation voltage to strain gage 62, for example at +2.5V; slip ring rotor terminal 68b is electrically connected to junction 62g and provides negative excitation voltage to strain gage 62, for example at −2.5V; slip ring rotor terminal 68c is electrically connected to junction 62h and receives a bridge high signal from strain gage 62; and slip ring rotor terminal 68d is electrically connected to junction 62e and receives a bridge low signal from strain gage 62. The positive excitation of +2.5V and the negative excitation of −2.5V is provided by an excitation supply 72 which is included in slip ring rotor 64a and which is supplied with +15V DC and −15V DC as will be described in greater detail later. Also included in slip ring rotor 64a is a differential amplifier 74, the inputs of which are from junction 62e and junction 62h via slip ring rotor terminal 68d and slip ring rotor terminal 68c respectively. Slip ring rotor 64a may include other features such as means 76 to calibrate strain gage amplifier 70 and means 77 to adjust the gain of differential amplifier 74. Means 76 and means 77 are known to those of ordinary skill in the art and will not be discussed further herein.

Slip ring stator 64b is fixed to slip ring rotor 64a through a suitable bearing (not shown) which allows slip ring stator 64b to remain stationary when slip ring rotor 64a is rotated about intake camshaft axis 24b. Slip ring stator 64b is used to provide a stationary connection point to allow inputs and outputs to be communicated to/from slip ring stator 64b/strain gage amplifier 70 and strain gage 62. Slip ring stator 64b includes slip ring stator terminals 78a, 78b, 78c, 78d, 78e, 78f which provide electrical connection to strain gage amplifier 70 through slip ring and brush arrangements 80a, 80b, 80c, 80d, 80e, and 80f respectively which allow rotation of slip ring rotor 64a relative to slip ring stator 64b while maintaining electrical communication therebetween. More specifically, slip ring stator terminal 78a is electrically connected to excitation supply 72 through slip ring and brush arrangement 80a and provides positive voltage thereto, for example +15V DC as mentioned previously; slip ring stator terminal 78b is electrically connected to excitation supply 72 through slip ring and brush arrangement 80b and provides negative voltage thereto, for example −15V DC as mentioned previously; slip ring stator terminal 78c is electrically connected to signal ground for excitation supply 72 through slip ring and brush arrangement 80c; slip ring stator terminal 78d is electrically connected to the output of differential amplifier 74 through slip ring and brush arrangement 80d and communicates the signal output high from slip ring assembly 64; slip ring stator terminal 78e is electrically connected to the signal ground for differential amplifier 74 through slip ring and brush arrangement 80e and provides the ground (signal output low) to which the signal output high is referenced; and slip ring stator terminal 78f is electrically connected to circuitry, i.e. means 76, of strain gage amplifier 70, through slip ring and brush arrangement 80a, which is used in calibration thereof.

The arrangement of strain gage 62 with strain gage patterns 62a, 62b, 62c, 62d arranged in a full bridge provides for some thermal compensation as is understood to those of ordinary skill in the art. However, in order to provide further thermal compensation, internal combustion engine 10 may include a temperature sensor 82, which may be implemented, by way of non-limiting example only, as a thermocouple. Temperature sensor 82 may be electrically connected to a controller 84 which receives an input from temperature sensor 82 which is indicative of relative temperature which strain gage 62 is subjected to in operation. In an alternative, temperature sensor 82 may be provided directly with camshaft torque measurement arrangement 38. Since the temperature of strain gage 62 may very during operation, for example due to internal combustion engine 10 warming from an initial temperature to an operating temperature after some period of time of operation, controller 84 is able to adjust the output of strain gage 62 and/or strain gage amplifier 70 to account for the temperature sensed by temperature sensor 82. In order to carry out adjustment of the output of strain gage 62 and/or strain gage amplifier 70 to account for the temperature sensed by temperature sensor 82, calibration can take place where the temperature is varied in a controlled environment and the output of strain gage 62 and/or strain gage amplifier 70 is mapped against temperature. From this mapping, a thermal compensation equation, usually a 4^{th} or 5^{th} order polynomial, can be derived using numerical or graphical methods. The thermal compensation equation can then be used to adjust the output of strain gage 62 and/or strain gage amplifier 70 to accommodate varying temperatures during operation. Controller 84 may include a processor (not shown) such as a microprocessor or other control circuitry such as analog and/or digital control circuity including an application specific integrated circuit (ASIC) for processing data as is known to those of ordinary skill in the art. Controller 84 may also include memory (not shown) including non-volatile memory, such as electrically erasable programmable read-only memory (EEPROM) for storing one or more routines, thresholds, and captured data. Controller 84, may also include a power supply for suppling the desired voltage to strain gage amplifier 70 via slip ring stator terminal 78a and slip ring stator terminal 78b. The one or more routines may be executed by the processor to perform steps to operate camshaft torque measurement arrangement 38. While controller 84 has been illustrated herein as a single controller, it should be understood that controller 84 may include multiple individual controllers. Furthermore, strain gage amplifier 70 may be included within controller 84 rather than within slip ring assembly 64. After optional processing of the signal from strain gage 62 and/or strain gage amplifier 70 is complete, controller 84 outputs the torque value, for example, to torque display 86 which may be, by way of non-limiting example only, a computer screen, digital or analog display, graph, or table.

Camshaft torque measurement arrangement 38 as described herein provides several benefits such as enabling torque measurement:
on an engine with live timing components (belt or chain), rather than cylinder head only;
with engine accessories such as GDI pump, vacuum pump and chain/belt tensioner installed;
during “fired-engine” conditions, which is critical for exhaust cam torque in turbo engine applications;
while installed in a vehicle; and
at a location outboard of the camshaft, which allows for all friction on the camshaft to be taken into account.
   Further benefits include separating high-cost strain gage torque meter from low cost adapters for use on different engine arrangements, providing thermal compensation, and providing geometry which is sensitive to changes in torque while remaining robust.

While camshaft torque measurement arrangement 38 has been illustrated as being used in connection with internal combustion engine 10 which is a fully operational internal combustion engine, it should now be understood that camshaft torque measurement arrangement 38 may alternatively be used in a non-functional internal combustion engine 10 or a subsystem thereof, for example a cylinder head which is removed therefrom.

While this invention has been described in terms of preferred embodiments thereof, it is not intended to be so limited.

We claim:

1. A camshaft torque measurement arrangement which measures torque on a camshaft which rotates about an axis, said camshaft torque measurement arrangement comprising:
a hub extending along said axis from a hub first end distal from said camshaft to a hub second end proximal to said camshaft such that said hub is configured to be fixed to an axial end of said camshaft;
a barrel extending along said axis from a barrel first end distal from said camshaft to a barrel second end proximal to said camshaft, said barrel having a barrel bore extending thereinto from said barrel second end such that said hub is received within said barrel bore in a close-sliding interface, wherein said barrel is fixed to said hub at a barrel to hub interface such that relative rotation between said barrel and said hub about said axis is prevented at said barrel to hub interface, and wherein said close-sliding interface does not contribute to transmission of torque between said barrel and said hub;
a strain gage on said barrel between said barrel second end and said barrel to hub interface which varies in resistance according to a magnitude of torque transmitted between said barrel and said camshaft.

2. A camshaft torque measurement arrangement as in claim 1, wherein:
said barrel bore is stepped, thereby defining a barrel bore shoulder which is traverse to said axis and which faces toward said barrel second end;
said hub first end axially abuts, and is fixed to, said barrel bore shoulder, thereby forming said barrel to hub interface.

3. A camshaft torque measurement arrangement as in claim 2, wherein said hub first end and said barrel bore shoulder are clamped together with a plurality of barrel to hub threaded fasteners.

4. A camshaft torque measurement arrangement as in claim 2, wherein said barrel comprises:
a barrel intermediate section which is tubular and has a first torsional rigidity;
a barrel first flange extending from said barrel first end to said barrel intermediate section, wherein said barrel first flange forms said barrel bore shoulder and wherein said barrel first flange has a second torsional rigidity which is greater than said first torsional rigidity; and
a barrel second flange extending from said barrel second end to said barrel intermediate section, wherein said barrel second flange has a third torsional rigidity which is greater than said first torsional rigidity.

5. A camshaft torque measurement arrangement as in claim 4, wherein said strain gage is located on said barrel intermediate section.

6. A camshaft torque measurement arrangement as in claim 4, wherein said barrel intermediate section includes a plurality of apertures extending radially therethrough from an outer surface thereof to said barrel bore.

7. A camshaft torque measurement arrangement as in claim 6, wherein said plurality of apertures make up at least 10% of a cross-sectional area of said barrel intermediate section when sectioned through said plurality of apertures in a direction perpendicular to said axis.

8. A camshaft torque measurement arrangement as in claim 4, wherein said barrel intermediate section has a thickness radially relative to said axis which is less than both said barrel first flange and said barrel second flange.

9. A camshaft torque measurement arrangement as in claim 2, further comprising a drive member configured to be driven and rotated about said axis, said drive member being fixed to said barrel proximal to said barrel second end at a drive member to barrel interface such that relative rotation between said drive member and said barrel about said axis is prevented at said drive member to barrel interface, wherein all torque transmitted from said drive member to said camshaft is through said barrel to hub interface.

10. A camshaft torque measurement arrangement as in claim 9, wherein said barrel comprises:
a barrel intermediate section which is tubular and has a first torsional rigidity;
a barrel first flange extending from said barrel first end to said barrel intermediate section, wherein said barrel first flange forms said barrel bore shoulder and wherein said barrel first flange has a second torsional rigidity which is greater than said first torsional rigidity; and
a barrel second flange extending from said barrel second end to said barrel intermediate section, wherein said barrel second flange has a third torsional rigidity which is greater than said first torsional rigidity.

11. A camshaft torque measurement arrangement as in claim 10, wherein said drive member and said barrel second flange are clamped together with a plurality of threaded fasteners.

12. A camshaft torque measurement arrangement as in claim 1, wherein said strain gage is a full Wheatstone bridge strain gage.

13. A camshaft torque measurement arrangement as in claim 1, wherein said close-sliding interface is less than or equal to 10 microns in radial clearance.

14. A camshaft torque measurement arrangement as in claim 1, further comprising a slip ring assembly having:
a slip ring rotor which is fixed to barrel such that said slip ring rotor rotates together with said barrel, said slip ring rotor having a plurality of slip ring rotor terminals electrically connected to said strain gage; and
a slip ring stator which remains stationary when said slip ring rotor rotates, said slip ring stator having a plurality of slip ring stator terminals which provide input to, and output from said slip ring assembly.

15. A camshaft torque measurement arrangement as in claim 14, wherein said slip ring rotor is clamped to said barrel with a plurality of slip ring assembly to barrel threaded fasteners.

16. A camshaft torque measurement arrangement as in claim 1, wherein said hub includes a hub bore extending axially therethrough from said hub first end to said hub second end such that said hub bore includes a hub bore first shoulder which faces toward said hub first end such that said hub bore first shoulder is traverse to said axis.

17. A camshaft torque measurement arrangement as in claim 16, further comprising an attachment bolt having a head which engages said hub bore first shoulder such that said attachment bolt clamps said hub to said camshaft.
